(19) United States
(12) Patent Application Publication
(10) Pub. No.: US 2003/0028903 A1
(43) Pub. Date: Feb. 6, 2003

(54) System and method for storing and processing data for display on a display device

(76) Inventors: Klaus Hofrichter, Santa Clara, CA (US); Adam Brownstein, New York, NY (US)

Correspondence Address: Florin Corie, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/920,273

(22) Filed: Jul. 31, 2001

(51) Int. Cl. H04N 7/16

(52) U.S. Cl. 725/151; 725/143; 725/148; 725/153

(57) ABSTRACT

A system and method for storing and processing data for display on a display device are described. Encoded data is received through a first digital connection. The encoded data is then processed in response to a request from a user to obtain multiple signals. Finally, the signals are transmitted to the display device through a second connection.

### FIELD OF THE INVENTION

The present invention relates generally to data storage systems and, more particularly, to a system and method for storing and processing data for display on a display device.

### BACKGROUND

Today's broadband access to networks, such as the Internet and its subset, the World Wide Web, through broadband technology, for example Digital Subscriber Line (DSL) technology, enables the download and storage of content files, for example audio and video data, to personal computer systems within a reasonable time. Several service providers, for example pay-per-view service providers, have been established to handle the download of audio and video data to consumers in exchange for payments from consumers.

However, the technologies used for the presentation of the downloaded audio/video data are not included in the services provided by the service providers and the viewing of downloaded data is limited to the computer platform. Typically, consumers must possess display technology, for example a video content decoder, and must watch the downloaded video material on the personal computer system. Since the video quality parameters of the downloaded audio/video data, such as resolution and aspect ratio, are calculated for television viewing, the viewing experience is affected.

### SUMMARY

A system and method for storing and processing data for display on a display device are described. Encoded data is received through a first digital connection. The encoded data is then processed in response to a request from a user to obtain multiple signals. Finally, the signals are transmitted to the display device through a second connection.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of one embodiment for a network architecture.

FIG. 2 is a block diagram of one embodiment for a client architecture within the network.

FIG. 3 is a block diagram of one embodiment for a computer system.

FIG. 4 is a block diagram of one embodiment for a system for storing and processing data within the client architecture.

FIG. 5 is a block diagram of an alternate embodiment for the system for storing and processing data within the client architecture.

FIG. 6 is a flow diagram of one embodiment for a method for storing and processing data for display on a display device.

### DETAILED DESCRIPTION

According to embodiments described herein, a system and method for storing and processing data for display on a display device are described.

In the following detailed description of embodiments of the invention, reference is made to the accompanying drawings in which like references indicate similar elements, and in which are shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

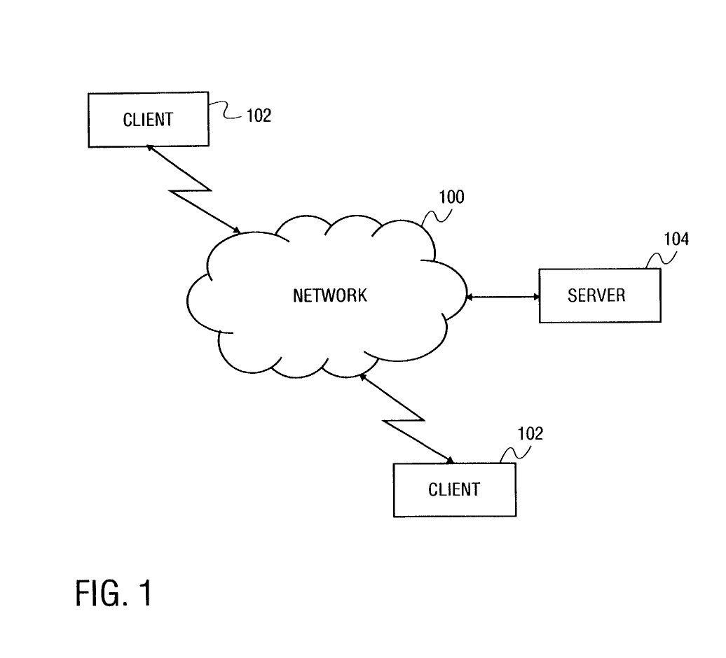

FIG. 1 is a block diagram of one embodiment for a network architecture. Referring to FIG. 1, the block diagram illustrates the network environment in which the present invention operates. In this conventional network architecture, a server computer system 104, for example a server operated by a service provider, is coupled to a network 100, for example a wide-area network (WAN). Wide-area network 100 includes the Internet, specifically the World Wide Web, or other proprietary networks, such as America Online™, CompuServe™, Microsoft Network™, and/or Prodigy™, each of which are well known to those of ordinary skill in the art. Wide-area network 100 may also include conventional network backbones, long-haul telephone lines, Internet service providers, various levels of network routers, unidirectional broadcast delivery devices, and other conventional means for routing data between devices. Using conventional network protocols, server 104 may communicate through wide-area network 100 to a plurality of client computer systems 102, possibly connected through wide-area network 100 in various ways or directly connected to server 104. For example, as shown in the embodiment of FIG. 1, client 102 is connected directly to wide-area network 100 through a digital broadband connection, or a direct or dial-up telephone connection or other network transmission line. Alternatively, client 102 may be connected to wide-area network 100 through a conventional modem pool (not shown) or other type of connection.

Using one of a variety of network connection devices, in one embodiment, server computer 104 can also communicate directly with client 102. In a particular implementation of this network configuration, a server computer 104 may operate as a web server if the World Wide Web (Web) portion of the Internet is used as wide-area network 100. Using the HTTP protocol and the HTML coding language across a network, web server 104 may communicate across the Web with client 102. In this configuration, client 102 uses a client application program known as a web browser, such as the Netscape Navigator™ browser, published by America Online™, the Internet Explorer™ browser, published by Microsoft Corporation of Redmond, Wash., the user interface of America Online™, or the web browser or HTML translator of any other conventional supplier. Using such conventional browsers and the Web, client 102 may access graphical and textual data or video, audio, or tactile data provided by server 104. Conventional means exist by which client 102 may supply information to web server 104 through the network 100 and the web server 104 may return processed data to client 102.

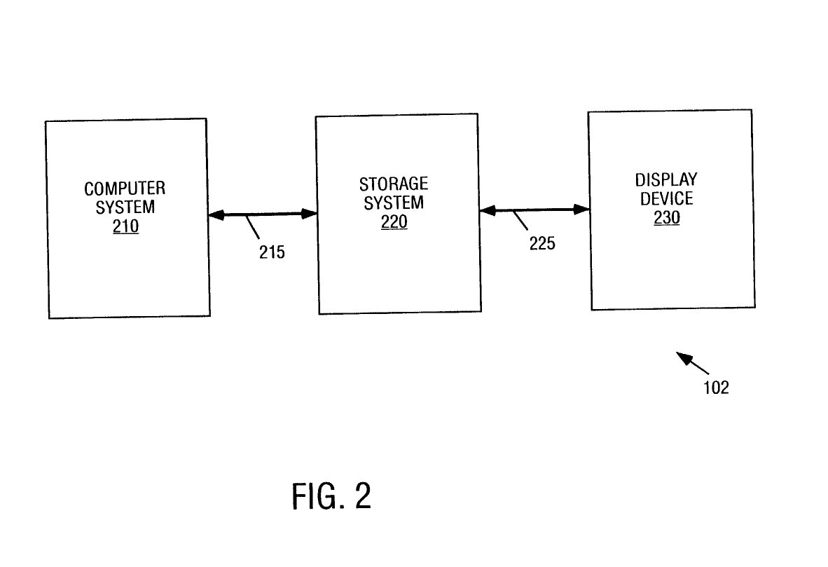

FIG. 2 is a block diagram of one embodiment for a client architecture within the network. As illustrated in FIG. 2, in one embodiment, server 104 may be connected to multiple clients 102 via a WAN 100. Client 102 further includes a computer system 210 connected to a storage system 220 via connection 215, for example a digital connection. In one embodiment, digital connection 215 is a high-speed broadband digital connection, for example an external bus, which supports the Institute of Electrical and Electronics Engineers (IEEE) 1394-1995 serial bus standard. Alternatively, digital connection 215 may be a Universal Serial Bus (USB) connection or any other type of high-speed digital connection.

In one embodiment, storage system 220 is connected to a display device 230, for example a television set, via connection 225, for example an analog connection. In one embodiment, analog connection 225 is a coaxial cable connection or any other known type of analog connection. Alternatively, storage system 220 may be connected to the display device 230 through a digital connection.

In an alternate embodiment, storage system 220 is connected to display device 230 via a set of analog connections including an analog audio connection and an analog video connection.

In another alternate embodiment, multiple storage systems 220 may be connected to the computer system 210. In one embodiment, the storage systems 220 are connected using a connection technique known as daisy chaining. In this embodiment, each storage system 220 has an input port, which receives data from the computer system 210 or a previous storage system 220 in the chain, and an output port, which transmits data to a subsequent storage system 220 in the chain or to the display device 230. Alternatively, computer system 210 includes multiple ports and each input port of storage systems 220 is connected to one port of the computer system 210.

In one embodiment, upon receipt of a request from a user, computer system 210 receives data, for example audio/video information, graphics, and/or text information, from server 104, for example a server operated by a service provider. Data is transmitted along digital connection 215 to the storage system 220. Storage system 220 stores data for subsequent display on the display device 230. If a user requests processing of the stored data for display on the display device 230, data is processed within storage system 220 and then transmitted via analog connection 225 to the display device 230.

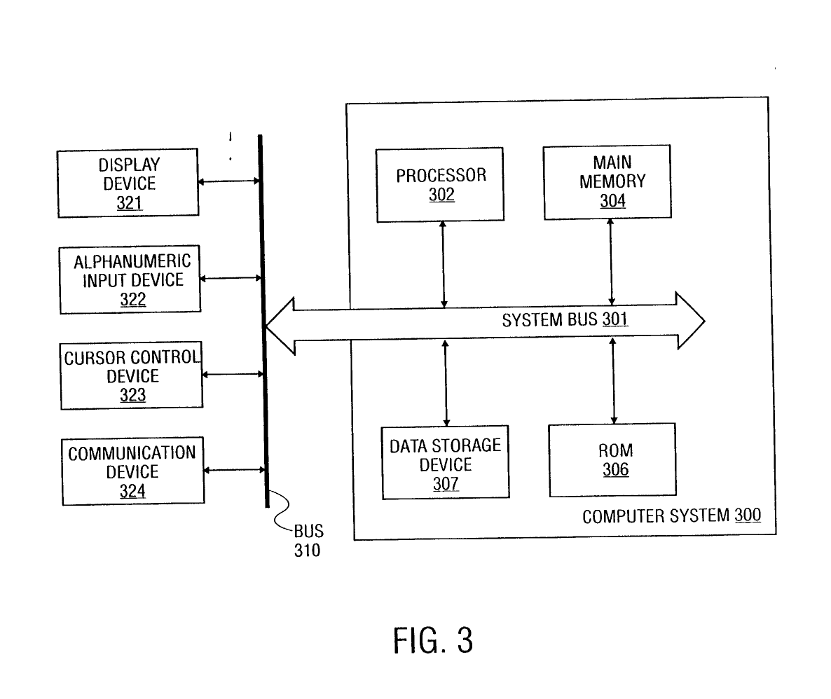

Having briefly described one embodiment of the network environment in which the present invention operates, FIG. 3 shows one embodiment of a computer system, which illustrates an exemplary client 102 or server 104 computer system in which the features of the present invention may be implemented.

In one embodiment, computer system 300 includes a system bus 301, or other communications module similar to the system bus, for communicating information, and a processing module, such as processor 302, coupled to bus 301 for processing information. Computer system 300 further includes a main memory 304, such as a random access memory (RAM) or other dynamic storage device, coupled to bus 301, for storing information and instructions to be executed by processor 302. Main memory 304 may also be used for storing temporary variables or other intermediate information during execution of instructions by processor 302.

In one embodiment, computer system 300 also comprises a read only memory (ROM) 306, and/or other similar static storage device, coupled to bus 301, for storing static information and instructions for processor 302.

In one embodiment, an optional data storage device 307, such as a magnetic disk or optical disk, and its corresponding drive, may also be coupled to computer system 300 for storing information and instructions. System bus 301 is coupled to an external bus 310, which connects computer system 300 to other devices. In one embodiment, computer system 300 can be coupled via bus 310 to a display device 321, such as a cathode ray tube (CRT) or a liquid crystal display (LCD), for displaying information to a computer user. For example, graphical or textual information may be presented to the user on display device 321. Typically, an alphanumeric input device 322, such as a keyboard including alphanumeric and other keys, is coupled to bus 310 for communicating information and/or command selections to processor 302. Another type of user input device is cursor control device 323, such as a conventional mouse, touch mouse, trackball, or other type of cursor direction keys, for communicating direction information and command selection to processor 302 and for controlling cursor movement on display 321. In one embodiment, computer system 300 may optionally include video, camera, speakers, sound card, and many other similar conventional options.

A communication device 324 is also coupled to bus 310 for accessing remote computers or servers, such as server 104, or other servers via the Internet, for example. The communication device 324 may include a modem, a network interface card, or other well-known interface devices, such as those used for interfacing with Ethernet, Token-ring, or other types of networks. In any event, in this manner, the computer system 300 may be coupled to a number of servers 104 via a conventional network infrastructure such as the infrastructure illustrated in FIG. 1 and described above.

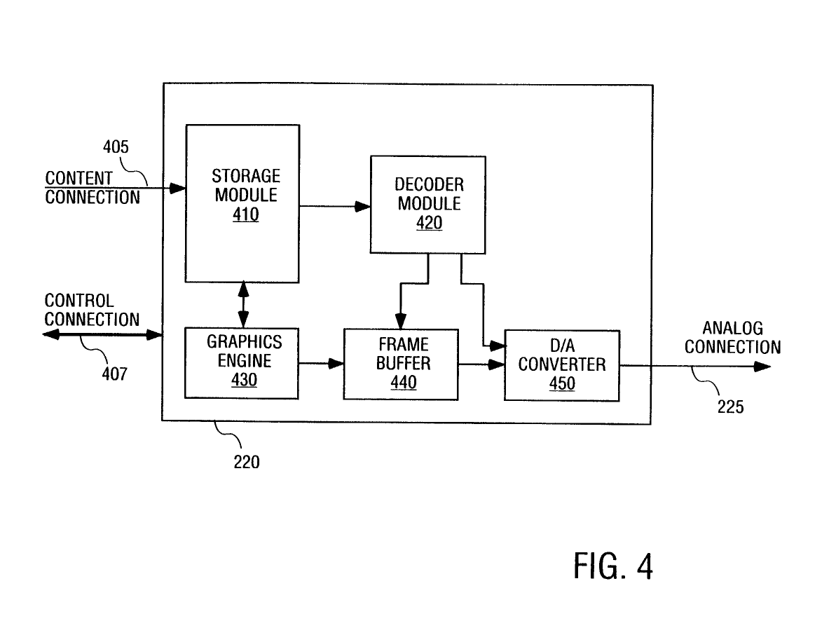

FIG. 4 is a block diagram of one embodiment for a system for storing and processing data within the client architecture. As illustrated in FIG. 4, in one embodiment, the system for storing and processing data or storage system 220 includes a storage module 410 for storing encoded data received from computer system 210 via digital connection 215 and a decoder module 420 coupled to storage module 410 for decoding the encoded data.

In one embodiment, computer system 210 transmits data, for example audio/video data, along a digital content connection 405 within digital connection 215. Storage module 410, for example an audio/video capable hard disk storage unit, receives and stores the data. In one embodiment, storage module 410 is a dedicated storage unit, which receives and stores data from computer system 210, but does not allow retrieval of the stored data by the computer system 210, thereby preventing digital copying of the stored data.

In one embodiment, audio/video data is received and stored in encoded format, for example a compressed format, such as the MPEG format or any other available compression format. In one embodiment, decoder module 420 is a video content decoder, for example an MPEG decoder, configured to read the encoded data from storage module 410 and to decode data for subsequent display on the display device 230.

In one embodiment, storage module 410 also stores graphics and/or text information associated with the encoded audio/video data. In one embodiment, graphics and/or text information are also transmitted along the digital content connection 405 from computer system 210.

In one embodiment, storage system 220 further includes a graphics engine 430 connected to the storage module 410 for retrieving the stored graphics and/or text information and for displaying the information on the display device 230.

In one embodiment, storage system 220 further includes a frame buffer 440 connected to the decoder module 420. In one embodiment, frame buffer 440 stores decoded data for a predetermined period of time prior to display on the display device 230, for example video data transmitted from decoder module 420 and graphics and/or text information transmitted from graphics engine 430.

In one embodiment, storage system 220 further includes a converter module, for example a digital-to-analog (D/A) converter 450, connected to frame buffer 440. In one embodiment, D/A converter 450 receives decoded video data from frame buffer 440 and converts the decoded video data into analog signals to be transmitted to the display device 230 via analog connection 225. In one embodiment, the D/A converter 450 also receives decoded audio data from decoder module 420 and converts the decoded audio data into analog signals to be transmitted to the display device 230 via analog connection 225.

In an alternate embodiment, the analog signals may be respectively transmitted to the display device 230 through a set of analog connections including an analog audio connection and an analog video connection.

In one embodiment, storage system 220 further includes a copy protection device (not shown) coupled to the D/A converter 450 for preventing the analog signals from being copied at the analog output.

In one embodiment, upon receipt of a request from a user to download encoded audio/video data, computer system 210 communicates with server 104 and receives encoded data from server 104. Computer system 210 transmits the encoded data to storage module 410 via digital content connection 405. Storage module 410 stores the encoded data. In one embodiment, if the user is a subscriber to a service provided by the content provider, which operates server 104, for example a pay-per-view service, computer system 210 transmits payment to server 104 for the download of the encoded audio/video data and then receives the encoded data from server 104.

In one embodiment, the user accesses computer system 210 and requests display of the encoded data on the display device 230. In one embodiment, the request is communicated to the computer system 210 through input device 322 or cursor control device 323. Alternatively, the request may be communicated to the computer system 210 through a remote control device (not shown). In one embodiment, computer system 210 further transmits the request to storage system 220 via a digital control connection 407 within digital connection 215.

In one embodiment, decoder module 420 retrieves and decodes encoded audio/video data stored within storage module 410. At the same time, graphics engine 430 retrieves graphics and/or text information associated with the audio/video data. In one embodiment, decoder module 420 transmits video data to frame buffer 440 and audio data to D/A converter 450. Alternatively, decoder module 420 may transmit audio data to a second D/A converter (not shown) for converting the audio data into analog signals and transmitting the analog signals to display device 230 via analog connection 225. In one embodiment, graphics engine 430 transmits graphics and/or text information to frame buffer 440 and adds the graphics and/or text to the video data stored in frame buffer 440. In one embodiment, decoded video data and associated graphics and/or text information are temporarily stored in frame buffer 440, for example for a predetermined period of time.

In one embodiment, the request to display data is communicated after storage module 410 receives and stores the encoded data. Alternatively, the request may be communicated after a predetermined amount of encoded data has been stored. In this embodiment, storage module 410 continues to receive and store encoded data from computer system 210 via digital content connection 405, while decoder module 420 retrieves and decodes encoded data already stored.

In one embodiment, D/A converter 450 converts the decoded audio/video data and associated graphics and/or text information into analog signals and transmits the analog signals to the display device 230 along analog connection 225. Analog data is then displayed on the display device 230. Alternatively, D/A converter 450 only converts the decoded video data and associated graphics and/or text information, while a second D/A converter (not shown) converts the decoded audio data into analog signals.

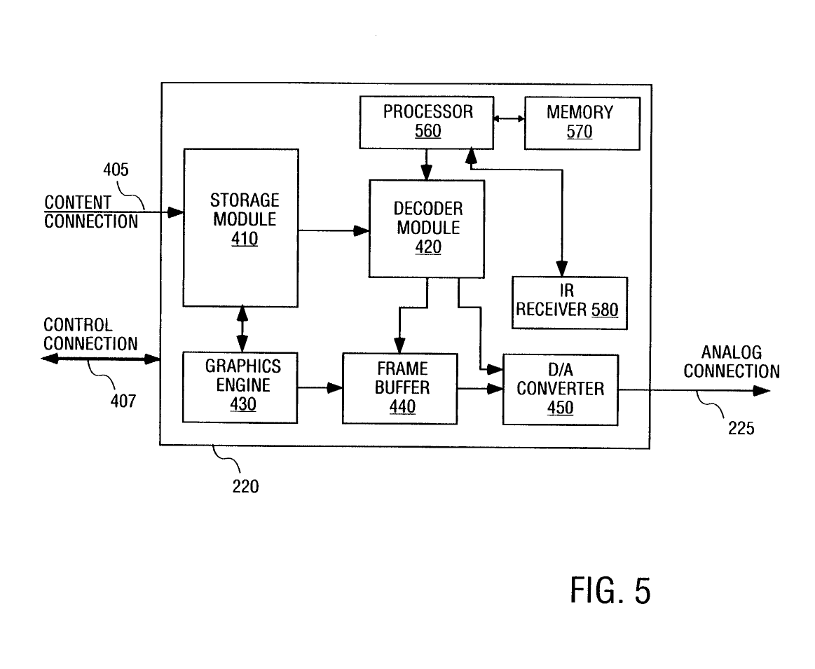

FIG. 5 is a block diagram of an alternate embodiment for the system for storing and processing data within the client architecture. As illustrated in FIG. 5, in one embodiment, in addition to storage module 410, decoder module 420, graphics module 430, frame buffer 440, and D/A converter 450, described in detail above, storage system 220 further includes a processor 560 and associated memory 570, and a receiver 580, for example an infrared (IR) receiver. In one embodiment, processor 560 controls the storage module 410, decoder module 420, and graphics engine 430 and executes instructions stored within memory 570.

In one embodiment, a user transmits the request to display encoded data to storage system 220 through a remote control device (not shown), which emits input signals, for example infrared signals. Alternatively, the remote control device may emit other type of input signals, such as radio wave signals.

IR receiver 580 receives the infrared signals from the remote control device and communicates the request to processor 560. Processor 560 interprets the request and instructs decoder module 420 and graphics module 430 to retrieve audio/video data and associated graphics and/or text information. Data retrieved is then processed and transmitted to the display device 230 in a manner similar to the embodiment described in connection with FIG. 4.

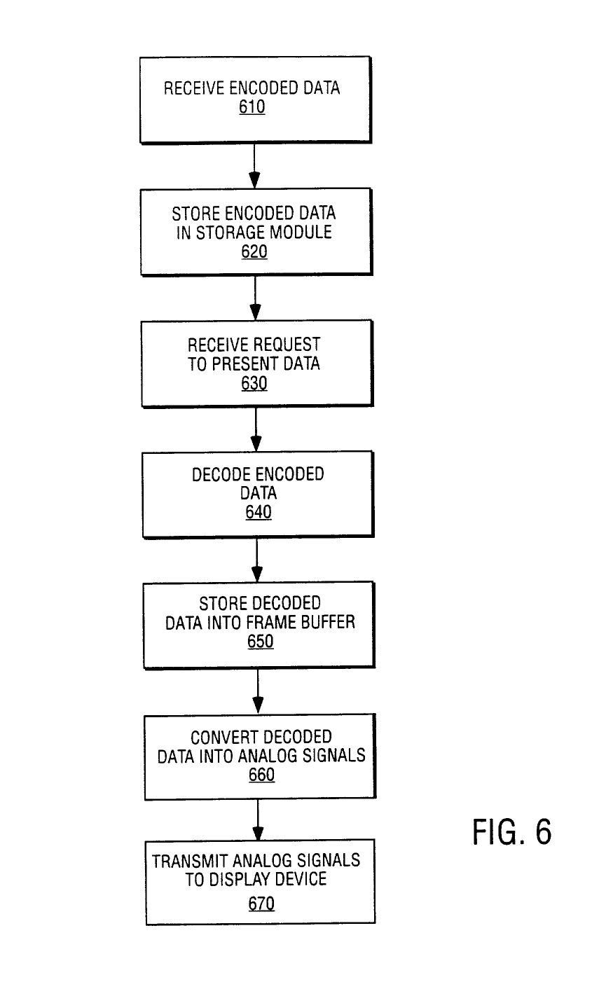

FIG. 6 is a flow diagram of one embodiment for a method for storing and processing data for display on a display device. As illustrated in FIG. 6, at processing block 610, encoded data is received within storage system 220. In one embodiment, computer system 210 transmits encoded data to storage system 220 via digital content connection 405 in response to a request from a user.

At processing block 620, encoded data is stored within storage module 410. In one embodiment, storage module 410 stores encoded audio/video data and associated graphics and/or text information.

At processing block 630, a request to present data is received within storage system 220. In one embodiment, the request is received from computer system 210 via digital control connection 407. Alternatively, the request may be received by a receiver 580 within storage system 220 from a user through a remote control device.

At processing block 640, encoded data is decoded. In one embodiment, decoder module 420 retrieves and decodes audio/video data and graphics engine 430 retrieves graphics and/or text information associated with the audio/video data. In one embodiment, decoder module 420 transmits video data to frame buffer 440 and audio data to D/A converter 450. Similarly, graphics engine 430 transmits graphics and/or text information to frame buffer 440. Alternatively, decoder module 420 transmits the audio data to a second D/A converter (not shown).

At processing block 650, decoded data is stored into frame buffer 440. In one embodiment, frame buffer receives and temporarily stores decoded video data and associated graphics and/or text information.

At processing block 660, decoded data is converted into analog signals. In one embodiment, D/A converter 450 converts decoded audio/video data and associated graphics and/or text information into analog signals. Alternatively, D/A converter 450 converts the decoded video data and associated graphics and/or text information, while a second D/A converter (not shown) receives and converts the decoded audio data into analog signals.

Finally, at processing block 670, analog signals are transmitted to display device 230 via analog connection 215.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving encoded data through a first digital connection;
processing said encoded data in response to a request from a user to obtain a plurality of signals; and
transmitting said plurality of signals to a display device through a second connection.

2. The method according to claim 1, wherein said receiving further comprises receiving said encoded data from a computer system through said first digital connection.

3. The method according to claim 1, wherein said receiving further comprises receiving said encoded data from a server operated by a service provider through said first digital connection.

4. The method according to claim 1, wherein said first digital connection is an external bus connection, which supports IEEE 1394 serial bus standard.

5. The method according to claim 1, wherein said first digital connection is a Universal Serial Bus (USB) connection .

6. The method according to claim 1, wherein said encoded data further comprises video data.

7. The method according to claim 1, wherein said encoded data further comprises audio data.

8. The method according to claim 1, wherein said processing further comprises storing said encoded data in a storage module.

9. The method according to claim 8, wherein said storage module is a dedicated audio/video capable hard disk storage unit.

10. The method according to claim 1, wherein said processing further comprises:
decoding said encoded data to obtain decoded data; and
converting said decoded data into said plurality of signals.

11. The method according to claim 1, wherein said processing further comprises receiving said request from a computer system through said first digital connection.

12. The method according to claim 1, wherein said processing further comprises receiving said request via an input signal from a remote control device handled by said user.

13. The method according to claim 10, wherein said decoding further comprises:
storing video data of said decoded data in a frame buffer together with graphics data associated with said video data; and
transmitting audio data of said decoded data to a converter module.

14. The method according to claim 13, wherein said converting further comprises:
retrieving said video data and said graphics data from said frame buffer; and
converting said audio data, said video data, and said graphics data into said plurality of signals.

15. The method according to claim 1, wherein each signal of said plurality of signals is an analog signal.

16. The method according to claim 1, wherein said second connection is an analog connection.

17. The method according to claim 1, wherein said receiving further comprises receiving said encoded data through a digital content connection within said first digital connection.

18. The method according to claim 1, wherein said processing further comprises receiving said request from a computer system through a digital control connection within said first digital connection.

19. The method according to claim 1, wherein said encoded data is audio/video data in a compressed format.

20. The method according to claim 13, wherein said video data is stored in said frame buffer for a predetermined period of time prior to being transmitted to said display device.

21. The method according to claim 1, wherein said display device is a television set.

22. A system comprising:
a storage module to receive encoded data through a first digital connection;
a decoder module to process said encoded data in response to a request from a user; and
a converter module to transmit a plurality of signals obtained from said encoded data to a display device through a second connection.

23. The system according to claim 22, wherein said storage module further receives said encoded data from a computer system through said first digital connection.

24. The system according to claim 22, wherein said storage module further receives said encoded data from a server operated by a service provider through said first digital connection.

25. The system according to claim 22, wherein said first digital connection is an external bus connection, which supports IEEE 1394 serial bus standard.

26. The system according to claim 22, wherein said first digital connection is a Universal Serial Bus (USB) connection.

27. The system according to claim 22, wherein said encoded data further comprises video data.

28. The system according to claim 22, wherein said encoded data further comprises audio data.

29. The system according to claim 22, wherein said storage module further stores said encoded data.

30. The system according to claim 22, wherein said storage module is a dedicated audio/video capable hard disk storage unit.

31. The system according to claim 22, wherein said decoder module further decodes said encoded data in response to said request to obtain decoded data.

32. The system according to claim 22, wherein said decoder module further receives said request from a computer system through said first digital connection.

33. The system according to claim 22, further comprising a receiver to receive said request via an input signal from a remote control device handled by said user.

34. The system according to claim 31, wherein said decoder module further stores video data of said decoded data together with graphics data associated with said video data in a frame buffer and transmits audio data of said decoded data to said converter module.

35. The system according to claim 34, wherein said converter module further retrieves said video data and said graphics data from said frame buffer and converts said audio data, said video data, and said graphics data into said plurality of signals.

36. The system according to claim 22, wherein each signal of said plurality of signals is an analog signal.

37. The system according to claim 22, wherein said second connection is an analog connection.

38. The system according to claim 22, wherein said storage module receives said encoded data through a digital content connection within said first digital connection.

39. The system according to claim 22, wherein said decoder module further receives said request from a computer system through a digital control connection within said first digital connection.

40. The system according to claim 22, wherein said encoded data is audio/video data in a compressed format.

41. The system according to claim 22, wherein said video data is stored in said frame buffer for a predetermined period of time prior to being transmitted to said display device.

42. The system according to claim 22, wherein said display device is a television set.

43. A computer readable medium containing executable instructions which, when executed in a processing system, cause the system to perform a method comprising:
receiving encoded data through a first digital connection;
processing said encoded data in response to a request from a user to obtain a plurality of signals; and
transmitting said plurality of signals to a display device through a second connection.

44. The computer readable medium according to claim 43, wherein said receiving further comprises receiving said encoded data from a computer system through said first digital connection.

45. The computer readable medium according to claim 43, wherein said receiving further comprises receiving said encoded data from a server operated by a service provider through said first digital connection.

46. The computer readable medium according to claim 43, wherein said first digital connection is an external bus connection, which supports IEEE 1394 serial bus standard.

47. The computer readable medium according to claim 43, wherein said first digital connection is a Universal Serial Bus (USB) connection.

48. The computer readable medium according to claim 43, wherein said encoded data further comprises video data.

49. The computer readable medium according to claim 43, wherein said encoded data further comprises audio data.

50. The computer readable medium according to claim 43, wherein said processing further comprises storing said encoded data in a storage module.

51. The computer readable medium according to claim 50, wherein said storage module is a dedicated audio/video capable hard disk storage unit.

52. The computer readable medium according to claim 43, wherein said processing further comprises:
decoding said encoded data to obtain decoded data; and
converting said decoded data into said plurality of signals.

53. The computer readable medium according to claim 43, wherein said processing further comprises receiving said request from a computer system through said first digital connection.

54. The computer readable medium according to claim 43, wherein said processing further comprises receiving said request via an input signal from a remote control device handled by said user.

55. The computer readable medium according to claim 52, wherein said decoding further comprises:
storing video data of said decoded data in a frame buffer together with graphics data associated with said video data; and
transmitting audio data of said decoded data to a converter module.

56. The computer readable medium according to claim 55, wherein said converting further comprises:
retrieving said video data and said graphics data from said frame buffer; and
converting said audio data, said video data, and said graphics data into said plurality of signals.

57. The computer readable medium according to claim 43, wherein each signal of said plurality of signals is an analog signal.

58. The computer readable medium according to claim 43, wherein said second connection is an analog connection.

59. The computer readable medium according to claim 43, wherein said receiving further comprises receiving said encoded data through a digital content connection within said first digital connection.

60. The computer readable medium according to claim 43, wherein said processing further comprises receiving said request from a computer system through a digital control connection within said first digital connection.

61. The computer readable medium according to claim 43, wherein said encoded data is audio/video data in a compressed format.

62. The computer readable medium according to claim 55, wherein said video data is stored in said frame buffer for a predetermined period of time prior to being transmitted to said display device.

63. The computer readable medium according to claim 43, wherein said display device is a television set.

64. A system comprising:
a storage system to receive encoded data through a first digital connection and to process said encoded data in response to a request from a user to obtain a plurality of analog signals; and
an analog display device coupled to said storage system to receive said plurality of analog signals through a second analog connection.

65. The system according to claim 64, further comprising a computer system coupled to said storage system to transmit said encoded data through said first digital connection.

66. The system according to claim 64, wherein said storage system receives said encoded data from a server operated by a service provider through said first digital connection.

67. The system according to claim 64, wherein said first digital connection is an external bus connection, which supports IEEE 1394 serial bus standard.

68. The system according to claim 64, wherein said first digital connection is a Universal Serial Bus (USB) connection.

69. The system according to claim 64, wherein said encoded data further comprises video data.

70. The system according to claim 64, wherein said encoded data further comprises audio data.

71. The system according to claim 64, wherein said storage system further stores said encoded data, decodes said encoded data in response to said request to obtain decoded data, and converts said decoded data into said plurality of analog signals.

72. The system according to claim 65, wherein said computer system further receives said request from said user and transmits said request to said storage system through said first digital connection.

73. The system according to claim 64, wherein said storage system further receives said request via an input signal from a remote control device handled by said user.

74. The system according to claim 64, wherein said storage system further receives said encoded data through a digital content connection within said first digital connection.

75. The system according to claim 72, wherein said computer system further transmits said request to said storage system through a digital control connection within said first digital connection.

76. The system according to claim 64, wherein said encoded data is audio/video data in a compressed format.

77. The system according to claim 64, wherein said analog display device is a television set.
